(19) United States
(12) Patent Application Publication
(10) Pub. No.: US 2007/0020144 A1
(43) Pub. Date: Jan. 25, 2007

(54) Functionalization of air hole arrays of photonic crystal fibers

(76) Inventors: Henry Du, Short Hills, NJ (US); Svetlana A. Sukhishvili, Maplewood, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/194,119

(22) Filed: Jul. 29, 2005

Related U.S. Application Data
(60) Provisional application No. 60/593,024, filed on Jul. 30, 2004.

(51) Int. Cl. G01N 21/00

(52) U.S. Cl. 422/58; 977/957

(57) ABSTRACT

An inventive sensor is used in combination with spectroscopic techniques to detect, identify and quantify ultratrace (ppt to ppb) quantities of analytes in air or water samples. The sensor preferably comprises a photonic crystal fiber having an air hole cladding with functionalized air holes. Surface-enhanced Raman spectroscopy is a preferred spectroscopic technique. In such applications, the air holes of the fiber may be functionalized by adsorbing a self-assembled monolayer on their inner surfaces, and immobilizing metallic nanoparticles to the monolayer. The invention has chemical and biomedical applications, and utility in detecting chemical and biological agents used in warfare.

### CROSS-REFERENCE TO RELATED APPLICATIONS

This application claims the benefit of U.S. Provisional Patent Application No. 60/593,024, filed Jul. 30, 2004, which is incorporated herein in its entirety.

### GOVERNMENT INTERESTS

The development of this invention was supported in part by the National Science Foundation under grant number ECS-0404002. The U.S. Government has certain rights in this invention.

### FIELD OF THE INVENTION

The present invention relates to the preparation and use of sensors for detecting and quantifying chemical or biological substances in air or water by spectrographic methods. More particularly, the invention relates to the modification of photonic crystal fibers for use in such sensors.

### BACKGROUND OF INVENTION

A photonic crystal fiber (PCF) is a silica fiber (e.g., a glass fiber) having a fine array of air holes running axially along its entire length. There are two types of PCF, as illustrated in FIGS. 1 and 2. FIG. 1 illustrates a solid-core PCF 10, having a silica core 12 with a high refractive index surrounded by an array of air holes 14 that form an air-silica cladding with a low refractive index. Typical PCFs have air holes 14 with diameters in the range of 0.01 to 0.1 μm. The contrast in refractive index between the solid core 12 and the air-silica cladding allows the silica core 12 of the PCF 10 to act as a wave guide by means of total internal reflection, as in a conventional optical fiber (i.e., light is guided in a solid-core PCF via total internal reflection at sufficiently shallow incidence or is otherwise refracted). FIG. 2 illustrates a hollow-core PCF 16 having a center air hole 18 surrounded by an air-silica cladding formed by air holes 20. With a properly designed cladding microstructure, the hollow-core PCF 16 can exhibit photonic band gap characteristics, resulting in a photonic band gap fiber (PBGF). A PBGF traps and guides light in the hollow core within a certain bandwidth, but otherwise refracts like a non-waveguiding capillary.

Fiber-optic sensors based on conventional all-solid optical fibers have long been explored for a wide range of sensing applications, relying on interaction between the evanescent field of a guided lightwave and the analyte as a common sensing scheme. The evanescent field extends only a small distance from the guiding core to the low-index cladding surrounding the fiber. Thus, evanescent wave sensors require that a section of the fiber cladding be completely or partially removed to allow the analyte to come within the interaction range of the evanescent field. The length of the fiber along which the evanescent field and the analyte interact is typically limited to a few centimeters because of the high attenuation of the field along the unclad fiber and the susceptibility of the exposed fiber core to damage failure. Thus, detection limits for such sensors are limited to the range of parts-per-million (ppm).

The use of PCFs as sensors has been shown to be feasible for sub-monolayer surface adsorbate, gas molecules, and biomolecules in solutions. Such feasibility, and the prospects for a much broader range of sensor applications, stem from the characteristics of PCFs in general. First, solid-core PCFs have unique optical characteristics, such as an endless single mode, a high non-linearity, low scattering loss, and near-zero dispersion of light. PBGFs, in particular, provide high-intensity transmission of light and, theoretically, zero attenuation. Second, there is a high degree of freedom for producing PCFs having desired optical properties by changing the cladding/core microstructure (i.e., size, pitch, and symmetry of the cladding air holes as well as size of the solid or hollow core) and for optimizing the mode field distribution of light wavelengths. Third, PCFs allow access of gas or liquids to the air holes and provide long interaction path lengths between the analytes and the light transmitted within the PCF.

The interactions between analytes and the transmitted light can be analyzed using spectroscopic methods, such as Raman scattering spectroscopy, for detection and identification of molecules. Raman scattering spectroscopy provides direct information on the vibrational energies of molecules and, as a result, creates molecular fingerprints. The cross section of Raman scattering is extremely small, typically about 10⁻³⁰ to 10⁻²⁵ cm²/molecule (compared with the effective cross sections of about 10⁻¹⁷ to 10⁻¹⁶ cm²/molecule for fluorescence spectroscopic methods widely used for single molecule detection). The small Raman cross section thus limits conventional Raman spectroscopy to identification, rather than sensitive detection, of molecules. However, a modification of Raman scattering spectroscopy (i.e., surface-enhanced Raman scattering spectroscopy, or SERS), whereby the scattering cross section of molecules using metallic nanostructures (typically, gold (Au) or silver (Ag)) can be enhanced by factors up to 10¹⁴, greatly expanding the capability of Raman scattering methods. It is generally noted that SERS results from two mechanisms: electromagnetic enhancement that has an effective range of 2-3 nm from a SERS-active surface; and chemical (electronic) enhancement that requires direct adsorption of molecules on the SERS-active surface. SERS is dominated by the electromagnetic mechanism. Techniques based on SERS have the potential to combine the sensitivity of fluorescence for single molecule detection with the stability and chemical specificity of Raman spectroscopy for molecular fingerprinting. Indeed, a large body of literature exists on SERS for sensing and measurement use. Examples include detection of single molecule adsorbates and genes, fingerprinting of DNA and RNA, and sensing of trace amounts (ppb to ppm) of selected chemical warfare agents (including their simulants or hydrolysis products) and explosives.

To date, there has been no viable portable and network-compatible technology for detection and molecular fingerprinting of chemical compounds in air and water at ultra-trace levels (i.e., ppt to ppb). Sensors based on PCFs with built-in functionality for SERS have the potential to enable ultra-sensitive, fiber-optic portable probes and analytical systems that are both robust and sensitive, with no false positive identifications and few false negatives.

### SUMMARY OF THE INVENTION

In a first aspect, the present invention comprises a sensor for use in detecting, identifying and/or quantifying chemical or biological analytes in samples of water or air. The sensor comprises an oxide surface, preferably a silica surface, a mediating layer, preferably a self-assembled monolayer, and at least one chemical moiety immobilized on the mediating layer. Immobilization of the chemical moiety is facilitated by functional groups, such as amine or thiol groups, exposed on the mediating layer.

A preferred embodiment of the sensor takes advantage of the optical properties of photonic crystal fibers. In such an embodiment, the mediating layer and chemical moiety are immobilized on the inner surfaces of the air holes of an air hole cladding surrounding the fiber core. It is preferred that solid core fibers be used in such sensors.

In a second aspect, the invention comprises a method for making the aforementioned sensor. The method includes the steps of selecting an oxide surface, immobilizing a mediating layer on the oxide surface, then immobilizing a chemical moiety on the mediating layer. The chemical moiety may be selected for its ability to interact with a specific analyte or group of analytes.

A third aspect of the invention comprises a method for detecting, identifying and/or quantifying chemical or biological analytes in samples of water or air using the aforementioned sensor. The method includes the simultaneous steps of contacting the sensor with a sample stream containing one or more analytes, irradiating the sensor with a laser source, collecting the electromagnetic radiation transmitted by the sensor, and analyzing the collected electromagnetic radiation using a spectroscopic method. It is believed that the most sensitive spectroscopic method for application to the inventive method would be surface-enhanced Raman spectroscopy. In such an application, the preferred sensor includes metallic nanoparticles immobilized on the mediating layer of the sensor. For most applications, sensors based on photonic crystal fibers are preferred.

In a fourth aspect, the invention includes systems that use the aforementioned sensor for detection, identification and/or quantification of analytes in water or air samples. Such systems comprise the sensor, a spectrometer and a laser source optically connected thereto, and a spectrum analyzer. These components may be arranged in a variety of systems for continuous monitoring or intermittent sampling, and as portable or stationary systems.

In its various aspects, the invention has applications in the chemical and biomedical fields. It has particular utility in the detection of ultratrace levels of chemical and biological warfare agents, and may be used in developing systems that provide early warnings of such agents.

### BRIEF DESCRIPTION OF DRAWINGS

FIG. 1 is a schematic diagram presenting a cross-section of a solid-core PCF and illustrating the reflection and refraction of collimated light in the solid core.

FIG. 2 is a schematic diagram presenting a cross-section of a hollow-core PCF and illustrating the reflection and refraction of collimated light in the hollow core.

FIG. 3 is a schematic diagram illustrating an arrangement of instrumentation for the continuous monitoring of analytes using a PCF-type detector according to the present invention.

FIG. 4 is a schematic diagram illustrating a portable arrangement of instrumentation for the intermittent sampling of analytes using a PCF-type detector according to the present invention.

FIG. 5 is a graph illustrating the changes in thickness of self-assembled monolayers (SAM) deposited on a silica surface at various combinations of ionic strength and pH.

FIG. 6 is a scanning electron micrograph of silver nanoparticles immobilized on a SAM formed at pH 7.

FIG. 7 is a scanning electron micrograph of silver nanoparticles immobilized on a SAM formed at pH 9.

FIG. 8 is a scanning electron micrograph of silver nanoparticles immobilized on a SAM after a contact time of 2 hours.

FIG. 9 is a scanning electron micrograph of silver nanoparticles immobilized on a SAM after a contact time of 4 hours.

FIG. 10 is a scanning electron micrograph of silver nanoparticles immobilized on a SAM after a contact time of 24 hours.

FIG. 11 is a graph showing SERS spectra for pure water and a dye adsorbed to a SAM, and a difference curve for the spectra.

FIG. 12 is a graph showing SERS spectra for a dye adsorbed to a SAM at different initial concentrations of dye in buffer solution.

FIG. 13 is a graph illustrating the chemical enhancement of a dye bound to a silver nanoparticle substrate in relation to increases in the ionic strength of the dye solution.

FIG. 14 is a graph illustrating the chemical enhancement of a dye on a Ag nanoparticle substrate with addition of sodium chloride at increasing concentrations.

FIG. 15 is a micrograph of a cross-section of a solid-core PCF.

FIG. 16 is a micrograph of a lateral section of the PCF of FIG. 15 showing immobilized silver nanoparticles.

FIG. 17 is a micrograph of a cross-section of a solid core PCF showing immobilized silver nanoparticles.

FIG. 18 is a micrograph of a lateral section of the PCF of FIG. 17 showing immobilized silver nanoparticles.

### DETAILED DESCRIPTION OF THE INVENTION

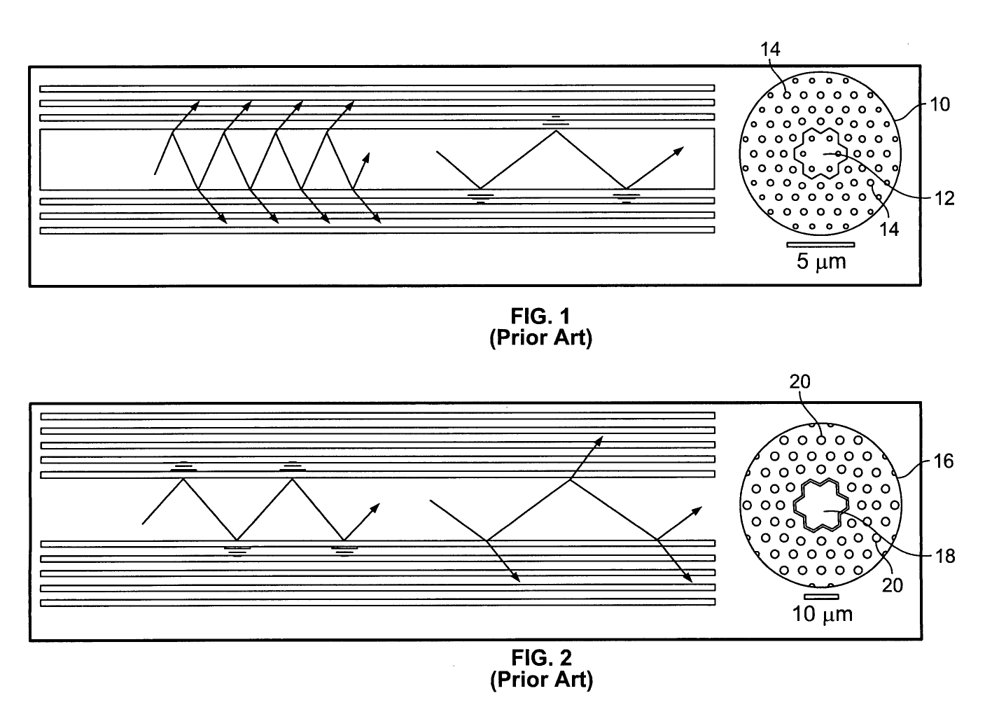

As discussed in the background section of this disclosure, FIGS. 1 and 2 illustrate a solid-core PCF 10 and a hollow-core PCF 16, respectively. Commercial and laboratory PCFs are generally manufactured by a “stack and draw” method, where silica capillaries and/or rods are placed in a closest-packed arrangement that is subsequently drawn into fiber. Another method is to form the PCF by sol-gel casting followed by fiber drawing. Sol-gel casting is a process in which high purity silica glass is generated from a dispersion of colloidal silica particles. Unlike the “stack and draw” approach, the sol-gel casting method enables the formation of PCFs having a wide range of cladding/core microstructure parameters (i.e., air hole size, pitch, symmetry, and core size). Such flexibility makes sol-gel casting a preferred method for forming PCFs for use in the present invention.

Solid-core PCFs are to be preferred over hollow-core PCFs for use in the present invention, although useful sensors may be developed from either type of fiber. Fundamentally, a hollow-core PCF with photonic band gap characteristics (i.e., a PBGF) allows optical transmission along the core within only a narrow bandwidth (typically about 10% of the center frequency). The characteristic Raman shifts of many analytes of interest are mostly in the range of about 500 to about 3000 cm⁻¹. Thus, under visible or near infrared laser excitation, the corresponding wavelengths of the Raman shifts will mostly be outside of the transmission window, severely limiting the use of the PBGF/SERS combination as a viable sensor. Further, a hollow-core PCF does not provide uniform and controlled flow of air or water due to the size differences between the cladding air holes and the hollow core. Hence, the solid-core PCF will be referred to by the acronym PCF henceforward.

Theoretical analysis indicates that mode field overlap with the cladding air holes of a PCF is a function of the cladding/core microstructure. A combination of small air holes, a small core, and large air filling fraction is predicted to produce a strong field overlap. From a practical standpoint, PCFs having very small air holes (e.g., about 1 μm) will not be feasible for use in sensors due to unrealistically high pressure requirements to sustain adequate gas or liquid flow. Table 1 shows theoretical correlations between pressure drop and air hole diameter for air and water flowing through one meter of PCF at 1 m/min, calculated using the Hagen-Poiseuille Law. For a given air hole diameter, a reduction in pressure drop, say by a factor of 100, can be achieved by decreasing the PCF length and the flow rate each by a factor of 10. Such reductions would be undesirable for use with field sensors, as they would be achieved at the expense of sensitivity and response time.

TABLE 1
Pressure drop over a 1 m PCF for air and water flowing at 1 m/min

| Air hole diameter (μm) | ΔPₐᵢᵣ (atm) | ΔP_{water} (atm) |
|---|---|---|
| 1 | 94.3 | 5270.2 |
| 3 | 10.5 | 586.2 |
| 6 | 2.6 | 146.1 |
| 10 | 0.9 | 52.7 |
| 30 | 0.1 | 5.9 |
| 60 | 0.03 | 1.5 |

One important aspect of the PCF/SERS sensors of the present invention is that the air holes of the air-silica cladding are activated to enable SERS for ultra-sensitivity and molecular fingerprinting. Such functionality can be introduced at the molecular and nanometer scales, by immobilizing monodispersed Au or Ag colloidal nanoparticles on the inner surfaces of the cladding air holes. Au may be selected for its excellent chemical stability, while Ag may be selected for its greater ability to enhance SERS. Preferably, the nanoparticles should have sizes in the range of 50 to 100 nm.

The Au or Ag nanoparticles are immobilized on a molecular layer, such as a self-assembled monolayer (SAM), adsorbed to the silica surface of the air hole. The strategy of SAM-mediated immobilization of Au and Ag nanoparticles encompasses the formation of SAMs on silica via surface silanization, followed by strong interaction between the exposed SAM surface (with either amine (—NH₂) or thiol (—SH) as functional tail groups) and the nanoparticles in a colloidal solution. Typical compounds that form SAMs include polyallylamine hydrochloride (PAH), or long-chain organo-silanes having amine or thiol tail groups. The SAM components should be selected to form hydrolytically stable SAMs, while inhibiting the formation of three-dimensional oligomers, formation of hydrogen bonds between the monomers, or association of the tail groups with the silica surface of the air holes.

One approach to overcoming these challenges is to start with the self-assembly of a long-chain bromo-terminated silane (1-bromo-16-(trichlorosilyl) hexadecane, or BTHD), that is known to form closely packed, ordered monolayers on a silica surface. After self-assembly, the bromo groups are then substituted by azide anions which are subsequently reduced to amine groups following procedures known in the art. Monodispersed Au or Ag nanoparticles are then immobilized by the amine groups. Another approach would be to start with the self-assembly of a monolayer of a compound having an amine or thiol group, such as polyallylamine hydrochloride (PAH), which would then adsorb the metallic nanoparticles. These approaches may be used to prepare a PCF or a planar silicon substrate. When preparing a PCF, the filling and removal of gas/liquid phases or purging of the cladding air holes at various stages of surface modification may be accomplished by coupling the PCFs with inlet/outlet cells under vacuum- or micropump-induced flow. The primary objective of purging is to achieve dense and uniform attachment of monodispersed Au and Ag nanoparticles over the entire length of the PCF without agglomeration of nanoparticles.

For practical applications, the stability and reversibility of PCF/SERS sensors must also be considered, since many environmental factors could interfere with their performance. For example, the effectiveness of SERS may be hampered by surface contamination, strong binding interactions with other reactive species in air or water, or variations in water pH. Accordingly, it may be desirable to modify the surfaces of the Au or Ag nanoparticles, for example, by using amine- or thiol-based SAMs to produce end-group functionalities at the surfaces of the metallic nanoparticles. An ideal SAM in this regard would have the following attributes: (1) a short chain length (e.g., a few tenths of a nanometer) so that adsorption on Au and Ag would not significantly compromise the SERS enhancement factors for an analyte; (2) formation of a stable and dense protective monolayer on Au and Ag nanoparticles against potential adverse environmental effects; (3) tail functional groups that selectively adsorb the analyte of interest, thus maximizing detection sensitivity and selectivity; and (4) desorption of the adsorbed analyte by a simple process such as heating at a moderate temperature or in-line gas or liquid purging. It is likely that different analytes will require the use of SAMs having functionalities specifically tailored for the analyte of interest.

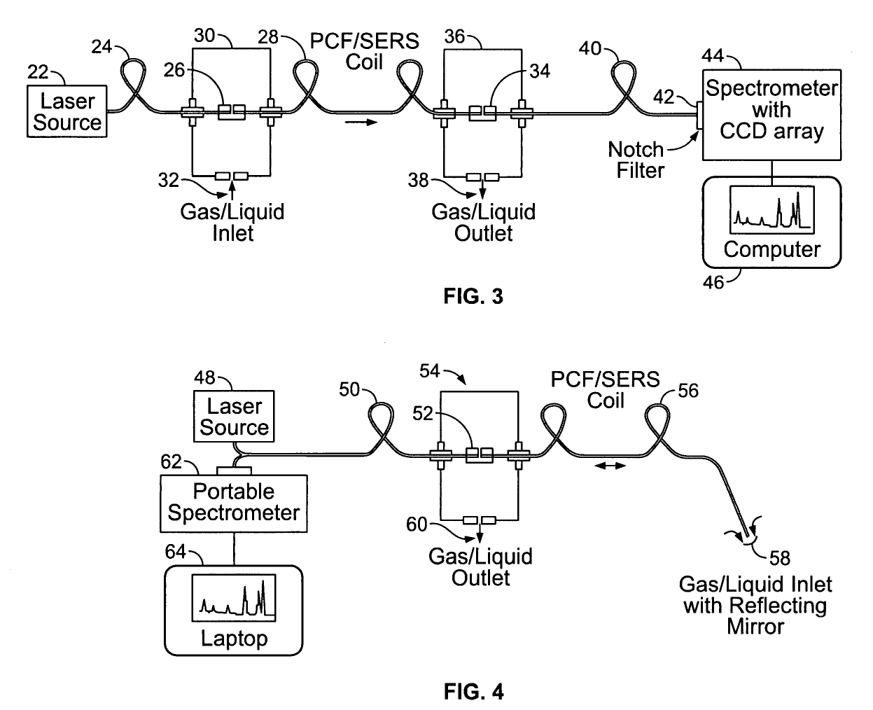

Detection and identification of analytes, whether entrained in air or dissolved in water, may be carried out at concentrations down to the ppt range using various arrangements of optical instrumentation. In a first arrangement, depicted in FIG. 3, collimated light from a laser source 28 is conveyed by an optical fiber coil 24 to a mechanical splice 26 wherein an end of the optical fiber coil 24 is optically aligned with an end of PCF/SERS coil 28. The mechanical splice 26 is located within a inlet cell 30 having an inlet 32 for gas or liquid samples. Samples enter the air holes in the air-silica cladding of PCF/SERS coil 28 at the mechanical splice 26 and are transported under pressure to mechanical splice 34, where the samples exit the PCF/SERS coil 28. The mechanical splice 34 is located within an outlet cell 36 having an outlet 38 for the gas or liquid samples. The mechanical splice 34 also optically aligns the end of the PCF/SERS coil 28 with an end of the optical fiber coil 40. Within the air holes of the PCF/SERS coil 28, the analytes in the sample are immobilized on the functionalized inner surface of the air holes where they interact with the collimated light from laser source 24 to produce a characteristic spectrum of wavelengths. The collimated light beam passes to a spectrometer 44, the output signal of which is analyzed by a computer 46 to identify the analytes by their characteristic spectrographs and quantify the presence of each analyte in the sample. Such an arrangement is suitable for continuous-flow sensing and monitoring as well as for in-situ measurements of the surface modification processes taking place in the air holes, using the PCF itself as a platform.

FIG. 4 illustrates a second arrangement that is suitable for use in portable field instruments. In this arrangement, one end of the PCF/SERS is used as both an analyte inlet for direct sampling of the environment, and as a port for reentry of the transmitted light upon reflection from a carefully positioned mirror. A small solid-state or semiconductor laser 48 provides a source of collimated light which is conveyed by an optical fiber coil 50 to a mechanical splice 52 located within a cell 54. The mechanical splice optically aligns an end of the optical fiber coil 50 aligned with an end of PCF/SERS coil 56. The other end of the PCF/SERS coil 56 is left open to act as an inlet for gas or liquid samples from the environment. A reflecting mirror 58 is positioned to return collimated light emitted by the PCF/SERS 56 back onto a return path through the PCF/SERS 56 and the optical fiber coil 50. As with the arrangement of FIG. 3, the analytes in the sample are immobilized on the functionalized inner surface of the air holes where they interact with the collimated light passing through the PCF/SERS 56 from laser source 24 to produce a characteristic spectrum of wavelengths. The sample exits the PCF/SERS 56 at the mechanical splice 52, and exits the cell 54 through an outlet 60. The collimated light beam passes through the optical fiber coil 50 to a portable spectrometer 62, the output signal of which is analyzed by a laptop computer 64 to identify and quantify the analytes.

### EXPERIMENTAL EXAMPLES

The following Examples are intended to aid in the understanding of the methods and apparatus of the present invention and are not intended to limit the scope or spirit of the invention in any way.

Experimental setup. The 532 nm wavelength light beam from a Laserglow D1-532 laser (Laserglow.com, Richmond Hill, Ontario, Canada) was spatially filtered and expanded three times, band-pass filtered, reflected from a Chroma Q540LP dichroic mirror (Chroma Technology Corp., Rockingham, Vt.), and then used to illuminate the back aperture of an Olympus 40× objective, N.A. 0.85 (Olympus America, Melville, N.Y.). The excitation light intensity in front of the objective was about 10 mW. The SERS signal collected from the sample by the same objective passed through the dichroic mirror, was filtered by a Kaiser SuperNotch filter (Kaiser Optical Systems, Inc., Ann Arbor, Mich.), and then was focused by a collimator into a spectroscopic grade multimode fiber having a 400 pm core (Newport Corp., Stamford, Conn.). A SERS active substrate was positioned at the bottom of a custom made glass cell attached to a Newport ULTRAlign 561D transition stage (Newport Corp., Stamford, Conn.) equipped with New Focus 8301 computer-controlled piezo actuators (New Focus, San Jose, Calif.). A fiber-coupled Acton SpectraPro 2300 spectrometer (Acton Research Corp., Acton, Mass.) with a Roper Scientific liquid nitrogen cooled CCD detector (Roper Industries, Inc., Duluth, Ga.) was used for spectrum acquisition. Spectrographic data were processed using Origin 7 software (OriginLab Corp., Southampton, Mass.).

Materials. The following reagents were purchased from the indicated suppliers and used without further purification: polyallylamine hydrochloride (PAH) having an average molecular weight M_{w}=70,000 g/mol⁻¹ (Aldrich), tris(hydroxymethyl) aminomethane (Trizma, reagent grade, Sigma), N-(2-hydroxyethyl) piperazine-N′-2-ethanesulfonic acid (HEPES, reagent grade, Fisher), sodium citrate dihydrate (enzyme grade, Fisher), sodium chloride (99.999%, Acros), and silver nitrate (ultrapure grade, Acros). Whatman Anodisc filter membranes with 100 nm pore size were used without further purification. The water was filtered with Barnstead ion-exchange columns and then further purified by passage through Milli-Q (Millipore) deionizing and filtration columns. All glassware was cleaned in Nochromix solution in sulfuric acid, followed by thorough washing with Milli-Q water.

Colloid preparation. A silver(Ag) colloid was prepared according to the standard citrate reduction protocol of Lee and Meisel. To eliminate the effect of nanoparticle size and shape on SERS activity, nanoparticle dispersions were diluted 10-fold with 10 mM HEPES buffer at pH 7.0 and then filtered through a 100-nm pore size membrane. After filtration, the colloidal nanoparticles were primarily of spherical shape, with an average size of 70±30 nm and zeta-potential of about −25±10 mV. SERS measurements showed that SERS bands obtained from Ag nanoparticles before and after filtration had comparable intensities.

Preparation of SERS-active silica substrates. The surface of the silica substrates was first hydrated by steam-treatment to make sure that sufficient hydroxyl sites were available for formation of a high-quality, densely packed PAH layer. The silica surface was then contacted with PAH in solution, allowing sufficient time for the monolayer (SAM) to self-assemble. In some tests, PAH was adsorbed from solutions containing sodium chloride(NaCl) at various ionic strengths, or at various pH. The PAH-covered surface was then brought into contact with colloidal Ag particles. After rinsing, the activated substrate was tested as in the following examples.

### Example 1

### Polymer Adsorption on the Surface of Silicon Wafers

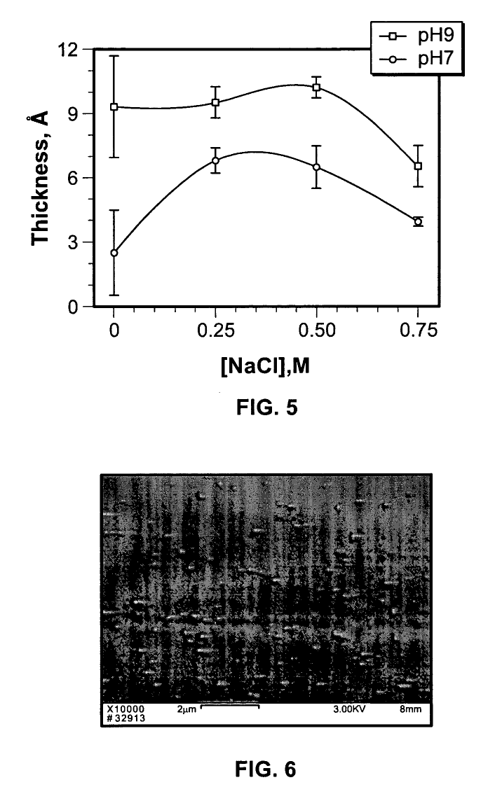

The effect of ionic strength and pH on adsorption of PAH on the surface of naturally oxidized silicon wafers is illustrated in FIG. 5. PAH was adsorbed from a solution buffered to pH 7 with HEPES or to pH 9 with Trizma at the ionic strengths shown. Data for FIG. 5 were obtained by ellipsometric measurements of thicknesses of dry polymer films of PAH SAMs formed on the planar surfaces. Two characteristic features SAM formation are demonstrated. First, one can see that when adsorption occurred from low ionic strength solutions, increasing the pH of the PAH solutions from 7 to 9 resulted in about a 3-fold increase in the amount of PAH bound to the surface. Second, while the amount of polymer deposited at pH 7 as a function of ionic strength went through a maximum, the maximum was not pronounced at pH 9. Without being bound to a particular theory, it appears that, at ionic strengths higher than a certain value, the Na⁺ ions compete with the charged polymer segments for access to the surface charged groups, causing a decrease in the amount of PAH adsorbed.

### Example 2

### Immobilization of Silver (Ag) Nanaparticles on a PAH-COATED Surface

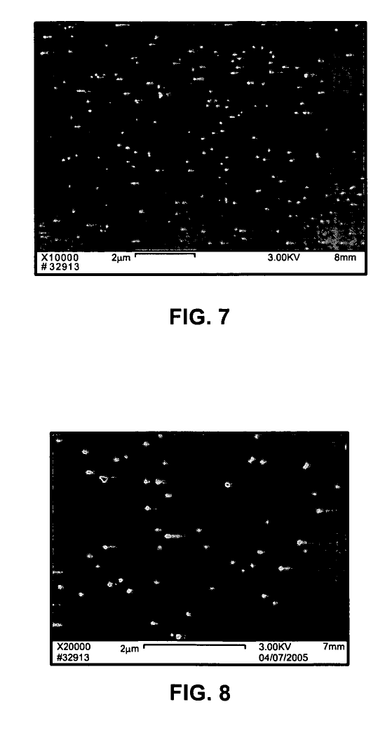

Since adsorption of charged polymers, such as PAH, results in the reversal of surface charge, PAH-treated surfaces can be used to immobilize Ag nanoparticles having negative charges at pH 7. FIGS. 6 and 7 are scanning electron micrographs of silver nanoparticles attached to a PAH SAM. The PAH SAM of FIG. 6 was preadsorbed from a 10 mM HEPES solution at pH 7, and the PAH SAM of FIG. 7 was preadsorbed from a 10 mM Trizma solution at pH 9, neither solution containing added NaCl. Silver nanoparticles were allowed to adsorb onto each PAH SAM from a colloidal suspension of 10¹² particles/ml at pH 7 for 4 hours. As can be seen in the micrographs, a significantly greater number of particles adsorbed to the PAH SAM formed at pH 9 (FIG. 7) than to the PAH SAM formed at pH 7 (FIG. 6). Table 2 shows that there is direct correlation between the density of adsorbed nanoparticles and the amount of preadsorbed PAH. Table 2 also shows that the ratio of the amount of adsorbed particles to the amount of adsorbed polymer remains constant for all adsorption conditions. Thus, variation of thickness of a preadsorbed PAH layer, through selection of the adsorption conditions, presents a facile means of controlling the surface density of immobilized Ag nanoparticles.

TABLE 2
Comparison of the thickness of a PAH SAM
against the surface density of Ag nanoparticles adsorbed on that SAM

| Conditions for PAH | | Ag nanoparticle density |
|---|---|---|
| adsorption | PAH thickness (Å) | (Particles per μm²) |
| pH 7, 0 M NaCl | 3 | 1.6 |
| pH 7, 0.25 M NaCl | 7 | 3.0 |
| pH 9.0, 0 M NaCl | 9 | 4.0 |
| pH 9, 0.25 M NaCl | 10 | 5.0 |

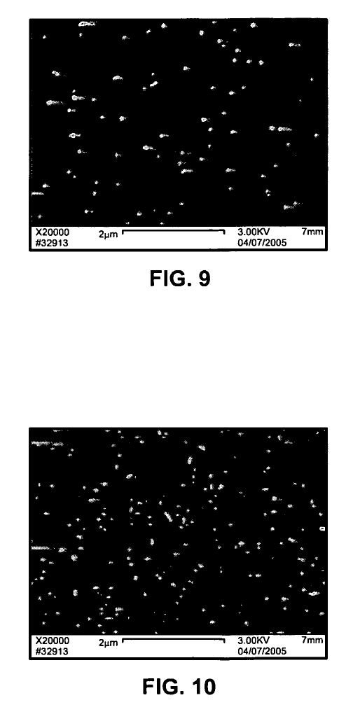

Another approach to controlling the density of Ag nanoparticles is to vary the contact time between the SAM and the Ag colloid. FIGS. 8, 9 and 10 are scanning electron micrographs of Ag nanoparticles adsorbed onto a PAH SAM over durations of time ranging from 2 to 24 hours. All three of the PAH SAMs were preadsorbed from a 10 mM Trizma solution at pH 9 and a NaCl concentration of 0.25 M. Clearly, the coverage of Ag nanoparticles increases with duration of contact. The nanoparticle densities were determined to be 3 particles/μm² (FIG. 8), 5 particles/μm² (FIG. 9), and 12 particles/μm² (FIG. 10) for contact times of 2, 4 and 24 hours, respectively.

### Example 3

### Sers Measurements of Rhodamin 6G (Rh6G) Deposited From Pure Water

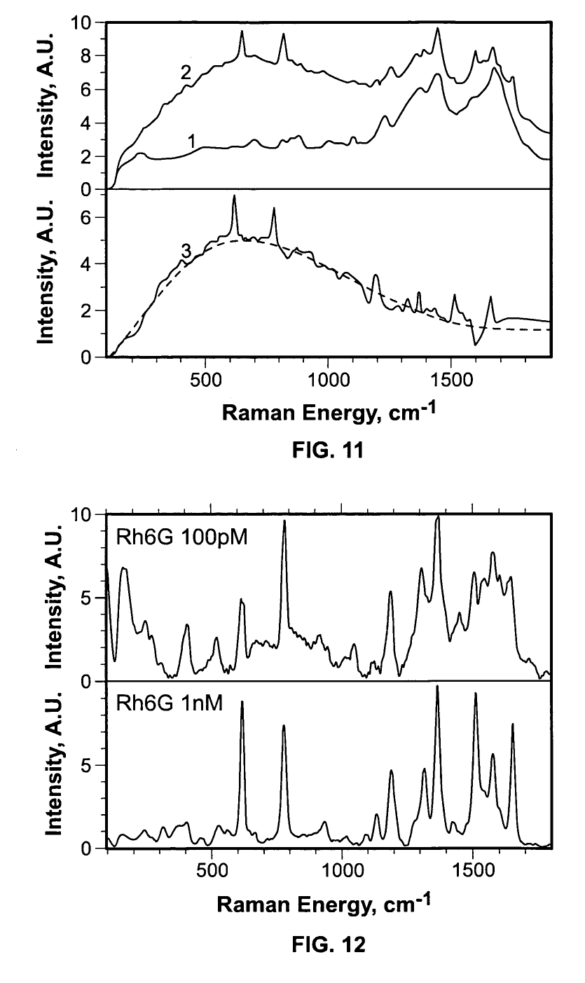

Substrates were prepared for spectroscopic measurements at a fixed contact time of 4 hours for Ag nanoparticle immobilization at a colloid concentration of 10¹² particle/ml. PAH SAMS were pre adsorbed at a contact time of 15 minutes from 0.2 g/l solutions at pH 9 having NaCl concentrations of 0.25 M. Substrates were then thoroughly rinsed with pH 9 Trizma buffer, before contact with the Ag nanoparticle colloid. The resulting substrates had a nanoparticle density of 5 particles/μm². Curve 1 of FIG. 11 shows a SERS spectrum of immobilized nanoparticles in pure water. Two wide vibrational bands centered at 1370 and 1585 cm⁻¹, which are usually assigned to graphitic carbon, are evident in the spectrum. Such bands may correlate with photo defragmentation of organic molecules bound to the Ag nanoparticles. The graphite peaks showed a fast growth over a time span of 5 to 10 seconds when the substrate was exposed to 10 mW laser radiation, but no significant increase in the intensity of these bands was observed after that time. Without being bound by any theory, we suggest that the observed appearance of graphite peaks reflects photodecomposition of contaminants in the colloidal dispersion. As has been reported in the prior art, the enhancement factor for the Raman cross-section of graphite is very large (3% of the monolayer coverage was easily detected) and comparable to that of Rh6G molecules. Consequently, a very small amount of contaminant molecules, in the range of pM to nM, could easily cause intense graphite peaks in the SERS spectrum.

The curves shown in FIG. 11 correspond to SERS substrates exposed to pure water at pH 5.5 (Curve 1); SERS substrates exposed to a 10 pM (5 ppt) aqueous solution of Rh6G solution, with no added NaCl (Curve 2); and a difference curve (Curve 3) obtained by subtracting the values of Curve 1 from those of Curve 2. The dashed line presented against Curve 3 represents the fluorescence background. The contact timw with the Rh6G solution was 15 minutes. At the end of the contact time, the substrates were rinsed several times with pure water to remove Rh6G in solution from the substrate. Measurements were taken over a period of 30 seconds, during which time the SERS substrates were exposed to 10 mW of laser radiation at a wavelength of 532 nm.

After the nanoparticle-modified substrates were exposed to the 10 pM Rh6G solution, spectral features characteristic to Rh6G emerged in the SERS spectrum collected from the substrate (see Curve 2, FIG. 11). The peaks were of moderate intensity and superimposed upon a broad Rh6G fluorescent background and graphitic peaks. Adsorption of Rh6G did not cause significant desorption of surface graphite, and or diminution of the background subtraction spectrum (see Curve 3, FIG. 11). From the known amount of Rh6G added, an upper limit of Rh6G coverage of 2 to 4 molecules per Ag nanoparticle was estimated, assuming that all available Rh6G molecules were adsorbed to an Ag surface. Since measurements were made using a laser beam with 90% of its intensity focused within 1 μm², fewer than 20 Rh6G molecules contributed to the SERS signal illustrated in FIG. 11. The moderate signals detected from adsorbed Rh6G in no salt aqueous solution were highly prone to fast photodegradation, and in a typical experiment, a SERS signal was not detectable after a 1 minute exposure of the substrate to 532 nm 10 mW laser radiation.

### Example 4

### Sers Measurements of Rhodamin 6G (Rh6G) Deposited From Buffer

The photobleaching observed in Example 3 was drastically reduced when the Ag nanoparticles were adsorbed for 15 minutes from 10 mM HEPES buffer at pH 7. The observed SERS spectra were highly stable and did not show any significant signs of photodegradation after exposure to 532 nm 10 mW laser light for as long as 15 minutes, as well as after multiple additional exposures of 2 to 3 minutes during the next 48 hours, for an overall additional exposure time of 20 minutes.

FIG. 12 presents the SERS spectra for adsorption of Rh6G where Ag nanoparticles and Rh6G were each adsorbed, in separate steps, from 10 mM HEPES solutions at pH 7. Rh6G was adsorbed from solution at initial concentrations of 100 pM (see upper curve) and 1nM (see lower curve). Background signals were subtracted from each curve. It may be seen that for adsorption from a 100 pM Rh6G solution, the contribution of the graphite peaks is still considerable. The relative contribution of the Rh6G bands becomes much larger for Rh6G adsorbed from a 1 nM solution. A sharp increase in the SERS signal of the dye is consistent with the low Rh6G surface coverage at all studied dye concentrations. The upper limit of Rh6G surface coverage on Ag nanoparticles was estimated as one molecule per 400 nm² when the dye was adsorbed from the 1 nM Rh6G solution.

### Example 5

### Activation of Sers by Halide Ions

Substrates with immobilized Ag nanoparticles showed exceptional stability in salt solutions. SEM measurements showed that nanoparticles, attached to the glass surface through SAM mediation, did not aggregate when treated with 0.25 M and 0.5 M NaCl solutions, demonstrating that the nanoparticles were strongly anchored to the substrate through polymer attachment. The low sensitivity of nanoparticle attachment to increased concentrations of salt is consistent with a significant contribution from non-electrostatic interactions, specifically, chemisorption of Ag nanoparticles onto the PAH-coated surface via Ag-N interactions. At all ionic strengths, the Ag nanoparticles were primarily immobilized as individuals, rather than as aggregates.

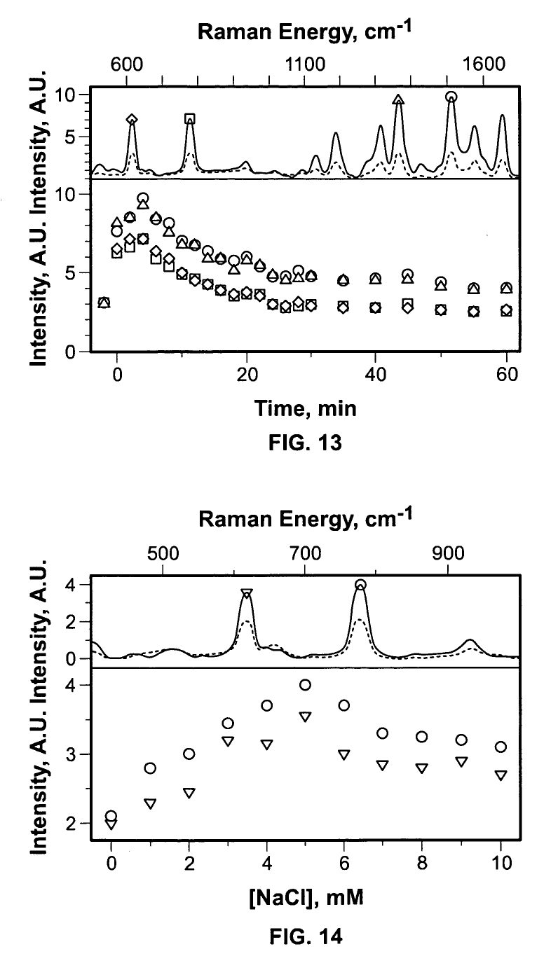

FIG. 13 illustrates the chemical enhancement of Rh6G bound to a Ag nanoparticle substrate caused by addition of 10 mM NaCl. The top panel shows SERS spectra before salt activation (dotted line) and after 4 minutes of exposure to 10 mM NaCl solution (solid line). The bottom panel shows the time evolution of the Raman intensities of four peak (i.e., peaks at 615, 775, 1365, and 1512 cm⁻¹) after addition of 10 mM NaCl solution. The leftmost points represent peak intensities before addition of salt. Rh6G was deposited for 15 min from 100 pM solutions in 10 mM HEPES at pH 7, followed by rinsing to remove excess dye. Spectra were detected using 10 mW laser radiation, 30 seconds of integration time, and 2 minute intervals between consecutive measurements. The bottom panel of FIG. 13 shows the time evolution of Raman integrated intensities of these four vibrational bands. It can be seen that the enhancement factor was moderate, up to 3-fold, with peak intensities going through a maximum 4 minutes after NaCl addition.

The dependence of chemical enhancement on the sodium chloride concentration is shown in FIG. 14. Two peaks at 615 cm⁻¹ and 775 cm⁻¹ were chosen because of the convenience of background subtraction in the 500-1000 cm⁻¹ spectral region, as seen in the top panel of FIG. 12. In this example, NaCl concentration was increased gradually by the addition of increasing amounts of NaCl, and SERS spectra were collected after each addition. A two-fold increase in SERS band intensities occurred across a range of 0 to 5 mM of NaCl concentration, which was followed a decay of intensity when cumulative exposure time increased further. The latter effect is similar to one seen in FIG. 13.

### Example 6

### Immobilization of Silver (Ag) Nanaparticles on the Inner Walls of Air Holes of Photonic Crystal Fibers

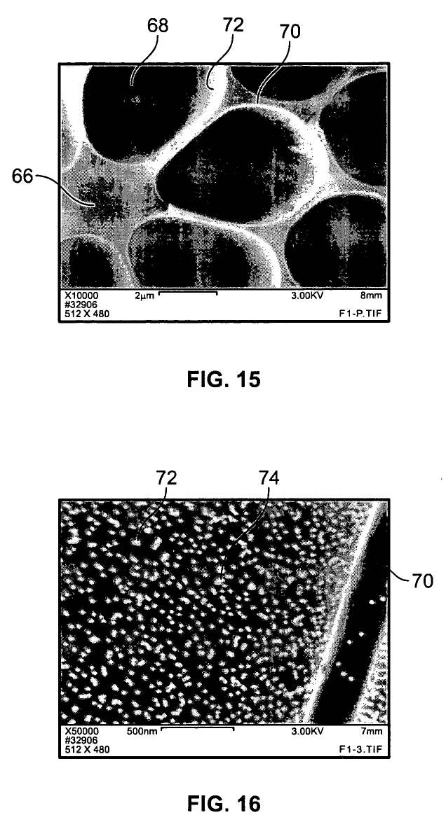

SAM-mediated immobilization of Ag nanoparticles was carried out in the air holes of a PCF, following procedures similar to those used in Examples 1-5. In a first test, a Ag colloid was prepared according to the standard citrate reduction of Lee and Meisel. FIG. 15 is a cross-section of a PCF, showing the solid core 66, and air holes 68 separated by a silica wall 70. Both ends of the PCF were cleaved nicely with a high precision cleaver, and installed in a pressure chamber that could apply a high pressure drop across the length of the PCF. The air holes of the fiber were purged with a solution of 0.2 mg/ml of PAH in a 0.01 M HEPES buffer at pH 9.0 with 0.25 M NaCl for 20 minutes, followed by a purge with a buffer solution of 0.01 M HEPES at pH 9.0 for 5 minutes. The purge solution was then changed to the Ag colloid and passed through the PCF for 72 hours. Upon completion of the colloid purge, the PCF was purged with purified water, followed by a purge with dry argon or nitrogen to dry the PCF. All purges were performed at a pressure drop of 200 psi. FIG. 16 shows that, as a result of the aforementioned procedures, Ag nanoparticles 74 are present at a high density and even distribution across the inner surface 72 of an air hole 68.

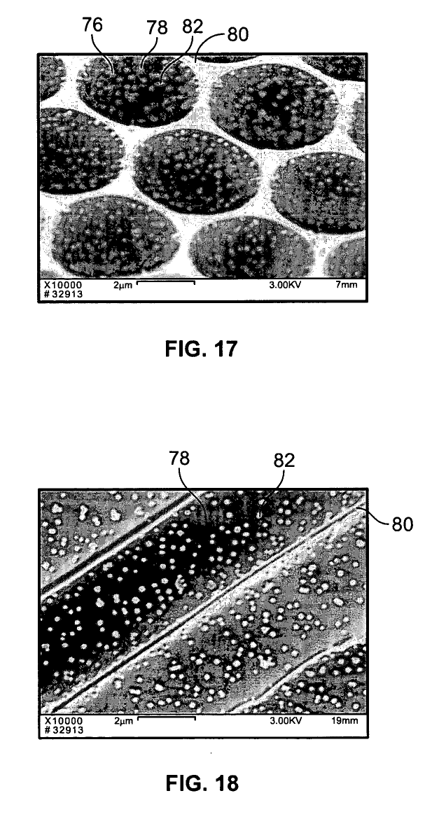

In a second procedure, a Ag nanoparticle colloid was prepared from equal volumes of 0.001 M AgNO₃ and 0.001 M HEPES adjusted to pH 3.0 with dilute HNO₃ and NaOH. Both ends of a PCF were cleaved nicely with a high precision cleaver, and installed in a pressure chamber that could apply a high pressure drop across the length of the PCF. The air holes of the PCF were purged with the Ag colloid for 10 minutes, then held within the PCF for 4 hours. This purge-and-hold step was repeated 10 times for a total contact time of over 40 hours. Upon completion of the colloid purge, the PCF was purged with purified water, followed by a purge with dry argon or nitrogen to dry the PCF. All purges were performed at a pressure drop of 200 psi. No PAH was included in any of the purge solutions. FIG. 17 is a cross-section of a treated PCF, showing that the inner walls 76 of the air holes 78 were coated with Ag nanoparticles 82. Comparison of FIG. 18 with FIG. 16 shows that the Ag nanoparticles 82 are present at a much lower density than the Ag nanoparticles 74 of the previous experiment. It is also apparent that the Ag nanoparticles 82 are much larger than the nanoparticles 74, and would, therefore, be less suitable for enhancement of SERS spectra.

The present invention represents the first known implementation of a PCF/SERS sensing strategy. In an embodiment discussed herein, the invention comprises robust SERS-active substrates by attaching discrete silver colloidal nanoparticles to polymer-coated glass or silica surfaces. Such substrates do not show nanoparticle detachment or aggregation when treated by high concentrations of salts and allow careful examination of the nature of chemical effects in SERS. Further, the present invention may be advantageously applied to the detection and fingerprinting of ultra-trace concentrations (i.e., concentrations in the ppt to ppb range) of chemical warfare agents in air and water. The robust and versatile sensing capability of a PCF/SERS system enables the implementation of proactive warn-and-prevent strategies, rather than reactive treat-and-recover strategies, for the protection of military forces and civilian populations. Further, PCFs may be functionalized with chemical compounds which would increase the specificity of the sensors for certain compounds by selectively trapping them at the inner surface of an air hole. For example, cavitands may be tailored to entrap specific airborne contaminants for analysis and adsorbed to a silica surface within the sensor.

In addition to chemical detection, PCFs may be adapted for biological applications. For example, avidin-biotin surface interaction is an excellent model system for ligand-receptor binding. Interactions between avidin and biotin are widely used to modify surfaces and to attach biological species to surfaces. An avidin-coated substrate can be treated with biotinated antibodies and antigens, producing ultra-thin films as a key element for immunosensors. Apart from an extremely high avidin/biotin binding constant, other advantages of such films include the mild conditions at which the film is formed, the efficient suppression of nonspecific adsorption of biomolecules and efficient preservation of biological functions of the attached biological species. The avidin-biotin recognition element can also be built on to Ag surfaces, with additional attachment of Ag nanoparticles, permitting SERS.

Another biological application is the use of PCFs in enzyme-based sensors. In enzyme-based biosensors, a biocatalytic reaction is used as the recognition element. The advantages of enzyme-based sensors include rapid response time, sensitivity and reactivation of the enzyme for continuous monitoring. While traditional enzyme immobilization techniques such as covalent binding or physical entrapment are being explored, new immobilization techniques have recently emerged. One example is layer-by-layer electrostatic self-assembly of enzymes with synthetic polyelectrolytes, producing enzyme-polymer multilayers. The advantage of this newer technique includes its noninvasive nature as well as the efficiency of coating a solid substrate. One type of enzyme-based sensor includes surface-immobilized organophosphorous hydrolase (OPH). OPH effectively hydrolyzes a number of organophosphorous compounds such as pesticides and chemical warfare agents, allowing direct optical detection of the products. For example, paraoxon can be detected through its hydrolysis product, p-nitrophenol, with an adsorption maximum at 400 nm. Electrochemical detection as applied to OPH-based sensors is another technique that may be applied to organophosphate detection.

It should be understood that the embodiments described herein are merely exemplary and that a person skilled in the art may make many variations and modifications thereto without departing from the spirit and scope of the present invention. All such variations and modifications, including those discussed above, are intended to be included within the scope of the invention as defined in the appended claims.

We claim:

1. An improvement to a method of analyzing a sample by simultaneously performing the steps of contacting a sensor with a sample stream, irradiating the sensor with a laser source, collecting electromagnetic radiation transmitted by the sensor, and analyzing the collected electromagnetic radiation using a spectroscopic technique, said improvement consisting of the step of providing the sensor with an oxide surface, a mediating layer immobilized on said oxide surface, and a chemical moiety immobilized on said mediating layer.

2. The improvement of claim 1, the providing step is performed by providing a photonic crystal fiber having a core and an air hole cladding located outside of the core, said air hole cladding having at least one air hole that extends throughout the length of the photonic crystal fiber, the at least one air hole having an inner surface, the inner surface comprising said oxidized surface, and the oxidized surface comprising oxidized silica.

3. The improvement of claim 2, wherein the core is a solid core.

4. The improvement of claim 1, wherein the mediating layer is a self-assembled monolayer.

5. The improvement of claim 1, wherein the chemical moiety comprises a metallic nanoparticle.

6. The improvement of claim 5, wherein the metallic nanoparticle comprises silver.

7. The improvement of claim 5, including the further improvement of performing the analyzing step using a surface-enhanced Raman spectroscopic technique.

8. The improvement of claim 1, including the further improvement of performing the analyzing step using a fluorescence spectroscopic technique.

9. The improvement of claim 1, wherein the chemical moiety is a first chemical moiety, the sensor further comprises a second chemical moiety, and said second chemical moiety is immobilized on said first chemical moiety.

10. The improvement of claim 1, wherein the chemical moiety interacts with an analyte from the sample.

11. The improvement of claim 10, wherein the chemical moiety is tailored to specifically interact with the analyte.

12. The improvement of claim 2, wherein the mediating layer comprises a self-assembled monolayer and the chemical moiety comprises a metallic nanoparticle, said improvement including the further improvement of performing the analyzing step using a surface-enhanced Raman spectroscopic technique

13. A method of making a sensor, including the steps of:
selecting an oxide surface;
forming a mediating layer on the oxide surface; and
immobilizing a chemical moiety on the mediating layer.

14. The method of claim 13, wherein said step of forming a mediating layer includes a step of exposing the oxide surface to a plurality of polymeric molecules, each polymeric molecule having a functional group, said exposing step being performed so as to form a self-assembled monolayer of the plurality of polymeric molecules on the oxide surface such that the functional groups are exposed.

15. The method of claim 13, wherein the functional group is selected from the group comprising an amine group and a thiol group.

16. The method of claim 14, further including a step of converting the plurality of functional groups to a plurality of other functional groups.

17. The method of claim 14, wherein said step of immobilizing a chemical moiety on the mediating layer is performed by exposing the mediating layer to the chemical moiety so that the chemical moiety becomes adsorbed onto the mediating layer by a process of adsorbing the chemical moiety to the functional groups.

18. The method of claim 17, wherein the chemical moiety is a metallic nanoparticle.

19. The method of claim 17, wherein said selecting step is performed by selecting a photonic crystal fiber having a core, an air hole cladding located outside of the core, the air hole cladding having at least one air hole that extends throughout the length of the photonic crystal fiber, the at least one air hole having an inner surface that comprises the oxide surface, the step of exposing the oxide surface is performed by passing a stream containing the plurality of polymeric molecules through the at least one air hole, and the step of exposing the mediating layer to the chemical moiety is performed by passing a stream containing the chemical moiety through the at least one air hole.

20. The method of claim 14, wherein said step of immobilizing a chemical moiety on the mediating layer is performed by exposing the mediating layer to the chemical moiety so that the chemical moiety becomes covalently bonded to the mediating layer by a process of covalently bonding the chemical moiety to one or more of the functional groups.

21. The method of claim 13, wherein the chemical moiety is a first chemical moiety, the method further including the step of immobilizing a second chemical moiety on the first chemical moiety.

22. The method of claim 13, wherein the oxide surface comprises silica,
said selecting step includes a step of selecting a photonic crystal fiber having a core and an air hole cladding located outside of the core, the air hole cladding having at least one air hole that extends throughout the length of the photonic crystal fiber, and the at least one air hole has an inner surface that comprises the oxide surface,
the step of forming a mediating layer on the oxide surface includes a step of passing a stream containing a plurality of polymeric molecules through the at least one air hole so as to form a self-assembled monolayer of the plurality of polymeric molecules on the oxide surface such that the functional groups are exposed,
and the step of immobilizing a chemical moiety on the mediating layer includes a step of passing a stream containing the chemical moiety through the at least one air hole.

23. A sensor, comprising:
an oxide surface;
a mediating layer immobilized on said oxide surface; and
at least one chemical moiety immobilized on said mediating layer.

24. The sensor of claim 23, wherein said oxide surface comprises silica.

25. The sensor of claim 24, further comprising a photonic crystal fiber having a core and an air hole cladding located outside of said core, said air hole cladding having at least one air hole that extends throughout the length of said photonic crystal fiber, said at least one air hole having an inner surface, and said inner surface comprising said oxide surface.

26. The sensor of claim 24, wherein the core is a solid core.

27. The sensor of claim 23, said mediating layer comprising a self-assembled monolayer.

28. The sensor of claim 23, wherein said at least one chemical moiety includes a metallic nanoparticle.

29. The sensor of claim 28, wherein said metallic nanoparticle comprises silver.

30. The sensor of claim 23, wherein said at least one chemical moiety includes a first chemical moiety immobilized on said mediating layer and a second chemical moiety being immobilized on said first chemical moiety.

31. The sensor of claim 23, wherein said at least one chemical moiety interacts with an analyte.

32. The sensor of claim 31, wherein said chemical moiety is tailored to specifically interact with the analyte.

33. The sensor of claim 23, further comprising a photonic crystal fiber having a core, an air hole outside of said core, said air hole extending throughout the length of said photonic crystal fiber, said air hole having an inner surface, and said inner surface comprising said oxide surface, wherein said oxide surface comprises silica, said mediating layer comprises a self-assembled monolayer, and said chemical moiety comprises a metallic nanoparticle.

34. A system for analyzing a sample, said system comprising a sensor having an oxide surface, a mediating layer immobilized on said oxidized surface, and a chemical moiety immobilized on said mediating layer; a spectrometer optically connected to said sensor; a laser source optically connected to said sensor; and a spectrum analyzer operationally connected to said spectrometer so as to transmit signals between said spectrometer and said spectrum analyzer.

35. The system of claim 34, wherein said sensor further has a photonic crystal fiber having a core and an air hole cladding located outside of said core, said air hole having an at least one air hole that extends throughout the length of said photonic crystal fiber, said at least one air hole having an inner surface, said inner surface comprising said oxide surface and said oxide surface comprising silica, said mediating layer comprises a self-assembled monolayer, and said chemical moiety comprises a metallic nanoparticle.

36. The system of claim 35, wherein said photonic crystal fiber has a first end and a second end, said system further comprising a first optical fiber having a first end and a second end; and a second optical fiber having a first end and a second end; said first end of said first optical fiber being optically aligned with said laser source, said second end of said first optical fiber being optically aligned with said first end of said photonic crystal fiber, said second end of said photonic crystal fiber being optically aligned with said first end of said second optical fiber, and said second end of said second optical fiber being optically connected with said spectrometer.

37. The system of claim 35, wherein said photonic crystal fiber has a first end and a second end, said system further comprising an optical fiber having a first end and a second end; and a mirror, said first end of said optical fiber being optically connected to said laser source and to said spectrometer, said second end of said optical fiber being optically connected to said first end of said photonic crystal fiber, and said mirror being positioned at said second end of said photonic crystal fiber so as to capture light emitted from said second end of said photonic crystal fiber and reflect the light at a 180 degree angle without obstructing said air hole in said photonic crystal fiber.
